(19) United States
(12) Patent Application Publication
(10) Pub. No.: US 2024/0177916 A1
(43) Pub. Date: May 30, 2024

(54) TRANSFORMER AND CIRCUIT BOARD COMPRISING SAME

(71) Applicant: LG INNOTEK CO., LTD., Seoul (KR)

(72) Inventors: Young Hwan JUNG, Seoul (KR); Yu Seon KIM, Seoul (KR); Seok BAE, Seoul (KR); Sun Young YU, Seoul (KR)

(21) Appl. No.: 18/551,207

(22) PCT Filed: Mar. 18, 2022
(86) PCT No.: PCT/KR2022/003848

§ 371 Date: Nov. 30, 2023

(30) Foreign Application Priority Data
Mar. 19, 2021 (KR) 10-2021-0036122
Mar. 18, 2022 (KR) 10-2022-0033942
Mar. 18, 2022 (KR) 10-2022-0034016

(51) Int. Cl. H01F 27/26; H01F 27/08; H01F 27/28

(52) U.S. Cl. CPC H01F 27/26; H01F 27/08; H01F 27/28

(57) ABSTRACT

The present invention relates to a transformer and a circuit board comprising same. One embodiment of the transformer according to the present invention comprises: a core part comprising a core lower portion and a core upper portion disposed on the core lower portion; and a coil part which comprises a first coil and a second coil and of which at least a portion is disposed in the core part, wherein the core lower portion has a closed region which overlaps the core upper portion in a first direction from the core lower portion toward the core upper portion, and an open region which extends from the closed region in a second direction perpendicular to the first direction and which is exposed to the outside of the closed area.

### TECHNICAL FIELD

The present disclosure relates to a transformer and a circuit board including the same.

### BACKGROUND ART

Illustratively, transformers are used for power supply units of display devices. As display devices become larger and slimmer, slim power supply units having high power density and high efficiency characteristics are required.

In order to meet requirements for high density and high efficiency, high-frequency power supply devices (e.g., LLC resonant converters) have been proposed as power supply devices for driving of LED backlights, which should have a wide voltage gain, and planar transformers have already been developed and used.

A planar transformer, for example, an LLC resonant converter, may secure desired leakage inductance by increasing leakage flux through a shape design of a core without inserting a separate leakage layer or I-type core between a primary coil and a secondary coil in order to obtain desired resonance characteristics.

Here, in order to obtain a stable output voltage even with a wide voltage gain, it is necessary to reduce leakage inductance, and therefore, a high-frequency planar transformer with low leakage inductance is needed.

In particular, in order to implement high-frequency driving of 160 to 300 kHz, the leakage inductance needs to be adjusted to be lower than before. However, a conventional EE core has high leakage inductance due to the shape thereof, and thus is not suitable for high-frequency driving.

In order to more precisely implement leakage inductance lower than before, it is necessary to change the structure of the conventional core.

### DISCLOSURE

### Technical Problem

An object of the present disclosure is to solve at least one of the above problems with the related art.

In particular, an object of the present disclosure is to provide a transformer capable of precisely implementing and further lowering leakage inductance compared to when a conventional EE core is applied thereto.

In addition, an object of the present disclosure is to provide a transformer in which a heat dissipation member is disposed to dissipate heat generated from a core unit and a coil unit, thereby minimizing an increase in temperature of the transformer, thus achieving thermal equilibrium in the transformer.

### Technical Solution

One embodiment of a transformer according to the present disclosure includes a core unit including a lower core and an upper core disposed on the lower core and a coil unit including a first coil and a second coil and at least partially disposed inside the core unit, wherein the lower core includes a closed area that is closed by overlapping with the upper core in a first direction oriented from the lower core to the upper core and an open area extending from the closed area in a second direction perpendicular to the first direction and exposed to the outside of the closed area.

In at least one embodiment of the present disclosure, a first center leg and a pair of first outer legs are disposed in the closed area of the core, a second center leg and a pair of second outer legs are disposed in the open area, and the first coil is wound so as to surround the first center leg and the second center leg.

In addition, in at least one embodiment of the present disclosure, the second center leg is disposed so as to be spaced apart from the first center leg by a predetermined interval, and the pair of second outer legs is disposed so as to be spaced apart from the pair of first outer legs by a predetermined interval.

In at least one embodiment of the present disclosure, the upper core includes a first upper center leg and a pair of first upper outer legs, and the lower core includes a first lower center leg and a pair of first lower outer legs.

Here, a gap may be formed between the first upper center leg and the first lower center leg and/or between the pair of first upper outer legs and the pair of first lower outer legs.

In at least one embodiment of the present disclosure, end surfaces of the first upper center leg, the pair of first upper outer legs, the first lower center leg, and the pair of first lower outer legs, facing the second center leg and the pair of second outer legs, are located on the same imaginary plane.

In addition, in at least one embodiment of the present disclosure, the second center leg includes a side end portion having a round shape.

In at least one embodiment of the present disclosure, the first coil is disposed in the closed area and the open area so as to surround the first center leg and the second center leg, and the second coil is disposed in the closed area so as to surround the first center leg.

Here, a portion of the second coil may be disposed beyond the closed area.

In at least one embodiment of the present disclosure, the thickness of the first coil is greater than that of the second coil.

In addition, in at least one embodiment of the present disclosure, the number of turns of the first coil is greater than that of the second coil.

In at least one embodiment of the present disclosure, the planar area of the open area is smaller than that of the closed area.

One embodiment of a circuit board according to the present disclosure includes the transformer of the above-described at least one embodiment.

Here, the transformer may be a transformer having leakage inductance of 15 to 20 μH at a frequency of 160 to 300 KHz.

In addition, other electronic components may also be mounted on the circuit board, and a plating line may be formed in a predetermined pattern on the surface of the circuit board in order to constitute an electric circuit of the components. In addition, such a circuit board may illustratively constitute an LLC resonant converter, and may be included in a power supply unit for display.

At least one embodiment of a transformer according to the present disclosure includes a core unit, which includes a lower core including a first lower center leg and a second lower center leg spaced apart from the first lower center leg by a first separation distance and an upper core disposed on the lower core and including an upper center leg overlapping the first lower center leg, and a coil unit, which includes a first coil disposed in a space defined by the first separation distance while surrounding the first lower center leg and the upper center leg and a second coil disposed outside the first coil to surround the first lower center leg, the upper center leg, and the second lower center leg, the first coil and the second coil being at least partially disposed inside the core unit, wherein the lower core includes a closed area in which the lower core overlaps the upper core in a first direction oriented from the lower core to the upper core and an open area extending from the closed area in a second direction perpendicular to the first direction and exposed from the upper core, wherein the second lower center leg has a first thickness in the second direction, and wherein the first coil and the second coil are spaced apart from each other by a first spacing distance that is equal to or greater than the first thickness.

The upper core may include a first upper outer leg and a second upper outer leg disposed in the closed area so as to be spaced apart from the upper center leg by a predetermined interval. The lower core may include a first lower outer leg and a second lower outer leg disposed in the closed area so as to be spaced apart from the first lower center leg by a predetermined interval, the second lower center leg, and a third lower outer leg and a fourth lower outer leg disposed in the open area so as to be spaced apart from the second lower center leg by a predetermined interval.

In addition, in at least one embodiment of the present disclosure, the upper center leg, the first upper outer leg, and the second upper outer leg may be disposed in the closed area so as to have a first length in the second direction, and the first lower center leg, the first lower outer leg, and the second lower outer leg, which have the first length in the second direction, may correspond to and overlap the upper center leg, the first upper outer leg, and the second upper outer leg, respectively.

In at least one embodiment of the present disclosure, the second lower center leg, the third lower outer leg, and the fourth lower outer leg, which have the first thickness, may be disposed in the open area. The second lower center leg, the third lower outer leg, and the fourth lower outer leg may be spaced apart from the first lower center leg, the first lower outer leg, and the second lower outer leg, respectively, by the first separation distance E1.

In at least one embodiment of the present disclosure, the upper core may include a first recessed portion, which is disposed between the upper center leg and the first upper outer leg and is relatively recessed by the upper center leg and the first upper outer leg, and a second recessed portion, which is disposed between the upper center leg and the second upper outer leg and is relatively recessed by the upper center leg and the second upper outer leg.

The lower core may include a fourth recessed portion, which is disposed between the first lower center leg and the first lower outer leg and is relatively recessed by the first lower center leg and the first lower outer leg, and a fifth recessed portion, which is disposed between the first lower center leg and the second lower outer leg and is relatively recessed by the first lower center leg and the second lower outer leg. The fourth recessed portion and the fifth recessed portion disposed in the closed area may overlap the first recessed portion and the second recessed portion, respectively.

In at least one embodiment of the present disclosure, the open area may include a third recessed portion, which is disposed between the second lower center leg and the first lower center leg spaced apart from each other by the first separation distance, between the third lower outer leg and the first lower outer leg, and between the fourth lower outer leg and the second lower outer leg and is relatively recessed by the second lower center leg, the first lower center leg, the third lower outer leg, the first lower outer leg, the fourth lower outer leg, and the second lower outer leg.

In at least one embodiment of the present disclosure, the first coil may include a first vertical coil portion extending in the second direction and at least partially penetrating the core unit, a 1-1^{st} horizontal coil portion extending in a third direction perpendicular to the second direction and disposed between the second lower center leg and the first lower center leg, and a 1-2^{nd} horizontal coil portion disposed opposite the 1-1^{st} horizontal coil portion, and the second coil may include a second vertical coil portion extending in the second direction and at least partially penetrating the core unit, a 2-1^{st} horizontal coil portion extending in the third direction perpendicular to the second direction, disposed adjacent to the second lower center leg, and disposed outside the closed area, and a 2-2^{nd} horizontal coil portion disposed opposite the 2-1^{st} horizontal coil portion.

Here, the 1-1^{st} horizontal coil portion and the 2-1^{st} horizontal coil portion may be spaced apart from each other by the first spacing direction.

In addition, the first vertical coil portion and the second vertical coil portion may be spaced apart from each other by a second spacing distance that is less than the first spacing distance.

The thickness of the first coil may be greater than that of the second coil.

The number of turns of the first coil may be greater than that of the second coil.

In at least one embodiment of the present disclosure, the first spacing distance may be equal to or greater than 2 mm and less than 10 mm.

In at least one embodiment of the present disclosure, the planar area of the open area may be smaller than that of the closed area.

In at least one embodiment of the present disclosure, the width of the first lower center leg formed in a third direction perpendicular to the second direction and the width of the second lower center leg formed in the third direction perpendicular to the second direction may be set to be equal to each other.

In at least one embodiment of the present disclosure, the width of the second lower center leg formed in a third direction perpendicular to the second direction may be greater than the width of the first lower center leg formed in the third direction perpendicular to the second direction.

Here, the first lower center leg formed in a third direction perpendicular to the second direction may have a first width, and the second lower center leg formed in the third direction may have a second width. The second width may be set to be greater than the first width by 10% to 30%.

In at least one embodiment of the present disclosure, a heat dissipation member may be further disposed in the open area so as to cover a portion of the first coil, a portion of the second coil, and a portion of the lower core.

Here, the heat dissipation member may be disposed so as to directly contact a portion of the coil unit, a portion of the upper core, and the lower core in the closed area.

In at least one embodiment of the present disclosure, the heat dissipation member may be disposed so as to directly contact one surface of the lower core, the thickness surface and the upper surface of the second lower center leg, the thickness surface and the upper surface of the third lower outer leg, and the thickness surface and the upper surface of the fourth lower outer leg, and may be disposed so as to directly contact the thickness surface of a first base of the upper core, the thickness surface of the upper center leg, the thickness surface of the first upper outer leg, and the thickness surface of the second upper outer leg.

Here, the heat dissipation member may be formed of any one of an alumina (Al₂O₃)-based material, a boron nitride (BN)-based material, a silicon (Si)-based material, and mixtures thereof.

In at least one embodiment of the present disclosure, the heat dissipation member may have insulating characteristics of 500 v/mm or more and thermal conductivity of 3.0 W/mK or more.

### Advantageous Effects

According to the present disclosure, a magnetic component suitable for high-frequency driving may be obtained.

In particular, the present disclosure may more precisely lower leakage inductance than a magnetic component having a conventional core structure. Leakage inductance when a conventional EE core is used may range from 25 to 30 μH, and the present disclosure may lower leakage inductance to, preferably, 15 to 20 μH.

According to the present disclosure, a spacing distance between a first coil and a second coil may be adjusted without adjusting the sizes of an upper center leg and a first lower center leg, thereby inducing leakage inductance having a desired magnitude while maintaining a constant self-inductance value Lp. Accordingly, DC-bias of the transformer may be increased at the same self-inductance Lp.

In addition, a heat dissipation member is disposed in the structure of the present disclosure to dissipate heat generated from a core unit and a coil unit, thereby minimizing an increase in temperature of the transformer, thus achieving thermal equilibrium in the transformer.

### DESCRIPTION OF DRAWINGS

FIG. 1 illustrates a transformer as one embodiment of magnetic components according to the present disclosure (illustration of a primary coil and a primary coil is omitted in FIG. 1).

FIG. 2 is an exploded perspective view of the transformer in FIG. 1 (both the primary coil and the secondary coil are shown in FIG. 2).

FIG. 3 illustrates cores shown in FIG. 2.

FIG. 4 illustrates a lower core among the cores in FIG. 3 ((a) illustrates a planar shape of the lower core, and (b) illustrates a front shape of the lower core).

FIG. 5 illustrates an upper core among the cores in FIG. 3 ((a) illustrates a planar shape obtained by turning the upper core shown in FIG. 3 over, and (b) illustrates a shape of the right surface of the upper core).

FIGS. 6 and 7 illustrate a first bobbin part shown in FIG. 2.

FIG. 8 illustrates a front view and a right view of the first bobbin part in FIG. 6.

FIGS. 9 and 10 illustrate a second bobbin part shown in FIG. 2.

FIG. 11 illustrates a state in which the first bobbin part 40 and the second bobbin part 30 are coupled to each other.

FIG. 12 illustrates a first embodiment of a method of winding the secondary coil in the present disclosure.

FIG. 13 illustrates a second embodiment of a method of winding the secondary coil in the present disclosure.

FIG. 14 illustrates a relationship between leakage inductance in the core according to the embodiment of the present disclosure and an interval.

FIG. 15 is a perspective view of a transformer as one of magnetic components according to another embodiment of the present disclosure.

FIG. 16 is a plan view of the transformer according to the other embodiment of the present disclosure.

FIG. 17 is a side view of the transformer according to the other embodiment of the present disclosure.

FIG. 18 is a perspective view of a core unit according to the other embodiment of the present disclosure, with a coil unit removed therefrom.

FIG. 19 is a plan view of an upper core and a lower core of the transformer according to the embodiment.

FIG. 20(a) is a graph showing leakage inductance measured in the conventional transformer having no open area, and FIG. 20(b) is a graph showing leakage inductance measured in the transformer according to the other embodiment of the present disclosure in which an open area is disposed.

FIG. 21 is a graph showing comparison in current density with respect to inductance between the transformer according to the other embodiment of the present disclosure and the conventional transformer.

FIG. 22 is a plan view showing a transformer according to still another embodiment of the present disclosure.

FIG. 23 is a plan view of a transformer according to a further embodiment of the present disclosure.

FIG. 24 is a side view of the transformer according to the further embodiment of the present disclosure.

### BEST MODE

The present disclosure may make various changes and have various embodiments, and specific embodiments are illustrated and described in the drawings. However, this is not intended to limit the present disclosure to a specific embodiment, and should be understood to include all changes, equivalents, or substitutes included in the spirit and technical scope of the present disclosure.

The suffixes “module” and “unit” used in this specification are only used for denominative distinction between elements, and should not be construed as presuming that the terms are physically and chemically distinguished or separated or may be distinguished or separated in that way.

Although terms including ordinal numbers, such as “first”, “second”, etc., may be used herein to describe various elements, the elements are not limited by these terms. These terms are only used to distinguish one element from another.

The term “and/or” is used to include any combination of a plurality of items that are the subject matter. For example, “A and/or B” inclusively means all three cases such as “A”, “B”, and “A and B”.

It will be understood that when a component is referred to as being “connected to” or “coupled to” another component, it may be directly connected to or coupled to another component, or intervening components may be present.

In the description of the embodiments, it will be understood that when an element, such as a layer (film), a region, a pattern or a structure, is referred to as being “on” or “under” another element, such as a substrate, a layer (film), a region, a pad or a pattern, the term “on” or “under” means that the element is directly on or under another element or is formed such that an intervening element may also be present. In addition, it will also be understood that criteria of “on” or “under” is on the basis of the drawing for convenience unless otherwise defined due to the characteristics of each of components or the relationship therebetween. The term “on” or “under” is used only to indicate the relative positional relationship between components and should not be construed as limiting the actual positions of the components. For example, the phrase “B on A” merely indicates that B is illustrated in the drawing as being located on A, unless otherwise defined or unless A must be located on B due to the characteristics of A or B. In an actual product, B may be located under A, or B and A may be disposed in a leftward-rightward direction.

In addition, the thickness or size of a layer (film), a region, a pattern, or a structure shown in the drawings may be exaggerated, omitted, or schematically drawn for the clarity and convenience of explanation, and may not accurately reflect the actual size.

The terminology used herein is for the purpose of describing particular embodiments only and is not intended to be limiting of exemplary embodiments of the disclosure. As used herein, the singular forms are intended to include the plural forms as well, unless the context clearly indicates otherwise. It will be further understood that the terms “include” or “have”, when used herein, specify the presence of stated features, integers, steps, operations, elements, components, or combinations thereof, but do not preclude the presence or addition of one or more other features, integers, steps, operations, elements, components, or combinations thereof.

Unless defined otherwise, all terms used herein, including technical or scientific terms, have the same meanings as commonly understood by one of ordinary skill in the art to which the present disclosure belongs. Terms such as those defined in commonly used dictionaries should be interpreted as having meanings consistent with the meanings in the context of the related art, and unless explicitly defined in this application, the terms should not be interpreted as having ideal or excessively formal meanings.

Hereinafter, embodiments of the present disclosure will be described in detail with reference to the accompanying drawings.

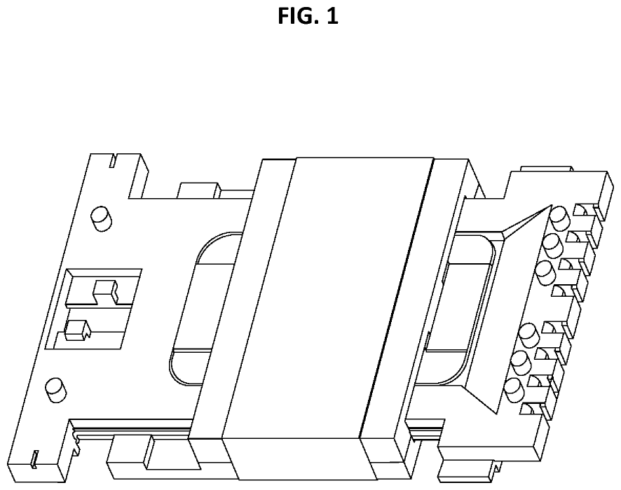

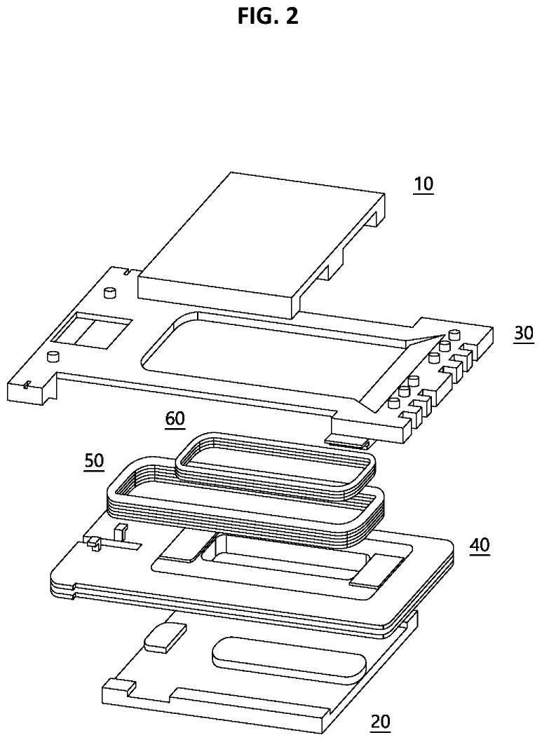

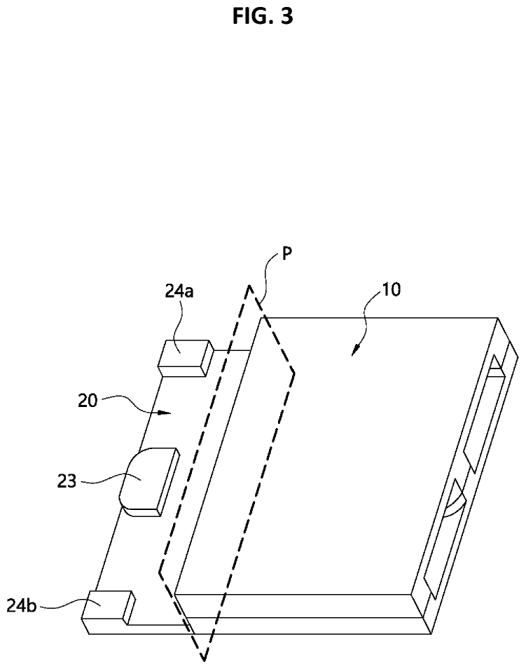

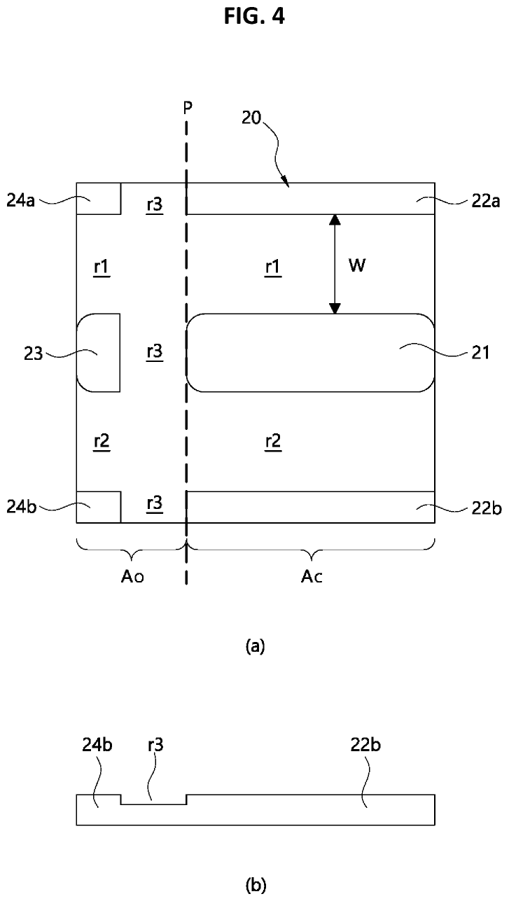

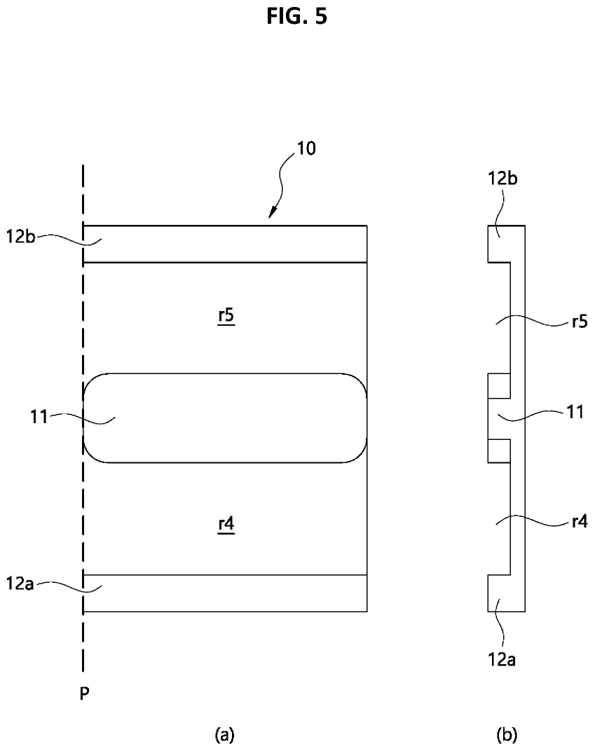

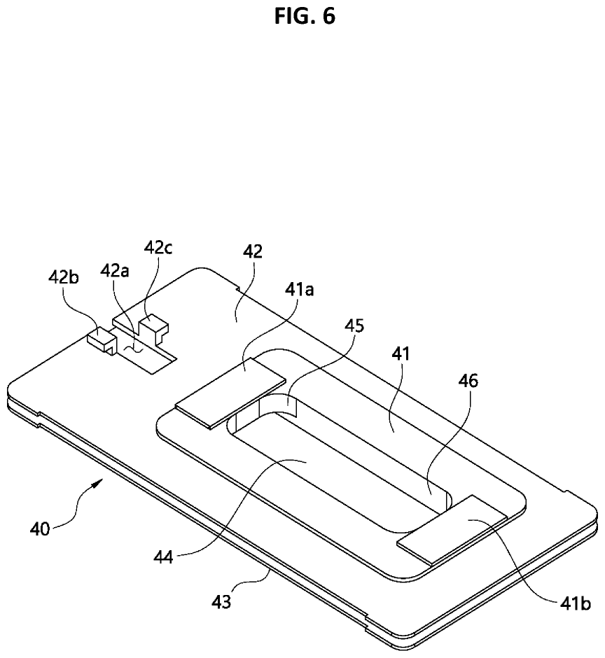

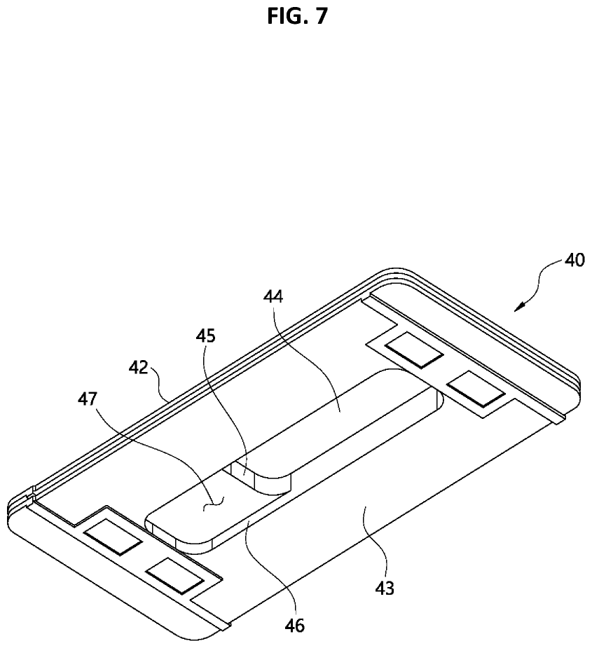

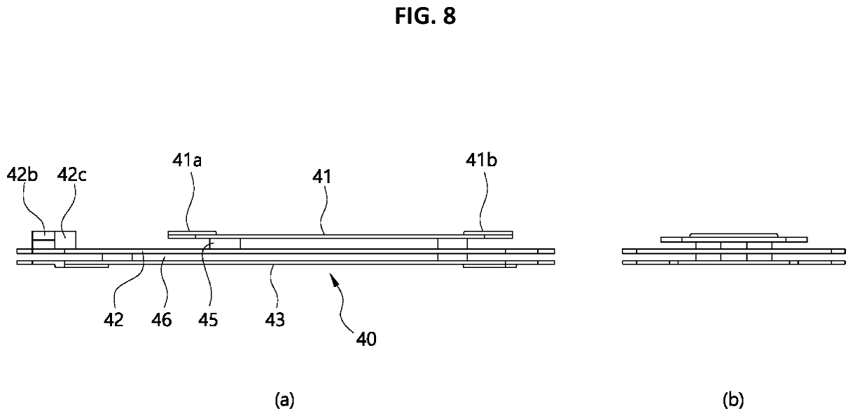

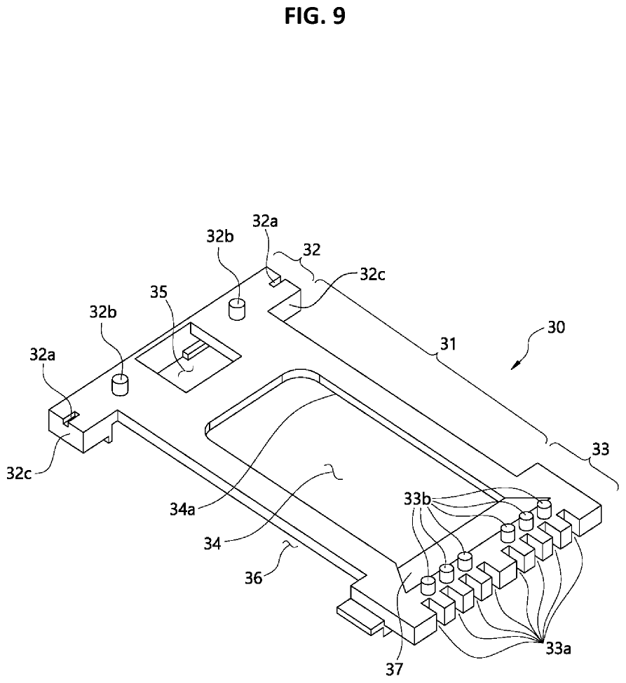

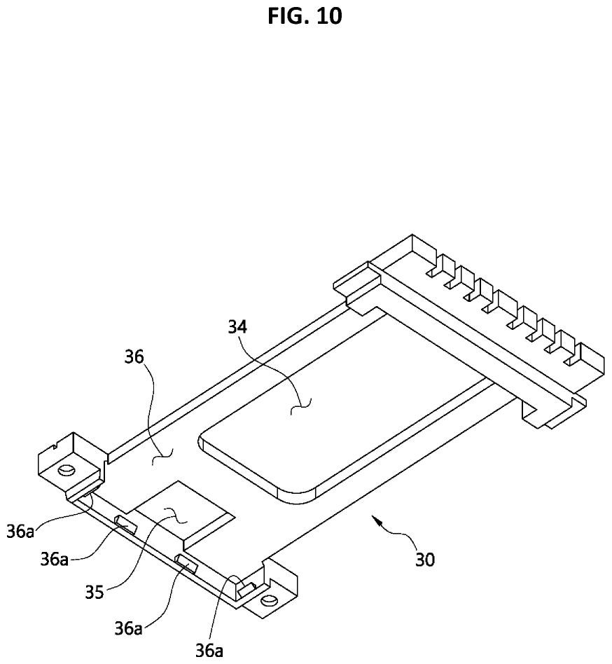

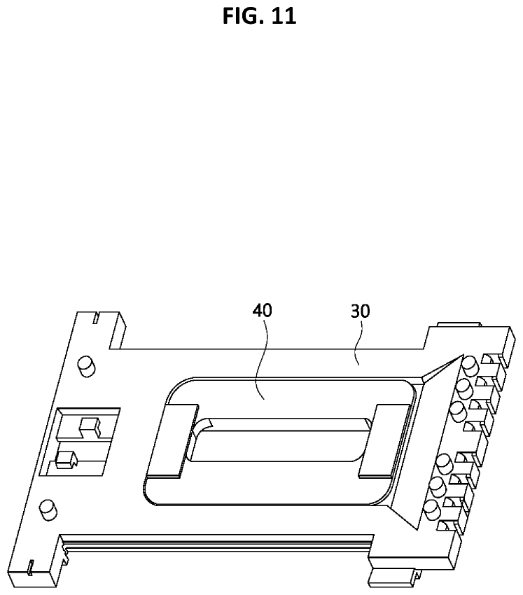

First, FIG. 1 illustrates a transformer as one embodiment of magnetic components according to the present disclosure (illustration of a primary coil 50 and a secondary coil 60 is omitted in FIG. 1). In addition, FIG. 2 is an exploded perspective view of the transformer in FIG. 1, FIG. 3 illustrates cores shown in FIG. 2, FIG. 4 illustrates a lower core 20 among the cores in FIG. 3 ((a) illustrates a planar shape of the lower core 20, and (b) illustrates a front shape of the lower core 20), FIG. 5 illustrates an upper core 10 among the cores in FIG. 3 ((a) illustrates a planar shape obtained by turning the upper core 10 shown in FIG. 3 over, and (b) illustrates a shape of the right surface of the upper core 10), FIGS. 6 and 7 illustrate a first bobbin part 40 shown in FIG. 2, FIG. 8 illustrates a front view and a right view of the first bobbin part 40 in FIG. 6, FIGS. 9 and 10 illustrate a second bobbin part 30 shown in FIG. 2, and FIG. 11 illustrates a state in which the first bobbin part 40 and the second bobbin part 30 are coupled to each other.

The core shown in FIGS. 1 and 2 will be described in detail with reference to FIGS. 3 to 5.

The core of this embodiment includes an upper core 10 and a lower core 20, and the upper core 10 is disposed on the lower core 20 so as to overlap the lower core 20 in a first direction oriented from the lower side to the upper side of the lower core 20, thereby forming one core.

The lower core 20 includes an open area Ao and a closed area Ac. The closed area Ac is defined as an area that is covered and closed by overlapping the upper core 10 in the first direction oriented from the lower core 20 to the upper core 10, and the open area Ao is defined as an area that extends from the closed area Ac in a second direction perpendicular to the first direction and is exposed to the outside of the closed area Ac without being covered by the upper core 10.

In this embodiment, the planar area of the open area Ao is smaller than the planar area of the closed area Ac.

In the closed area Ac, a first lower center leg 21 and a pair of first lower outer legs 22a and 22b disposed with the first lower center leg 21 interposed therebetween are formed.

Here, corner portions of the first lower center leg 21 include round shapes, and corner portions of the first lower outer legs 22a and 22b include angled shapes (including round shapes having a much smaller radius than the round shapes of the first center leg). However, the disclosure is not limited thereto.

Recessed portions r1 and r2 are formed on both sides of the first lower center leg 21, and thus the first lower outer legs 22a and 22b are spaced apart from the first lower center leg 21 by intervals equivalent to the recessed portions.

In the open area Ao, a second center leg 23 and a pair of second outer legs 24a and 24b disposed with the second center leg 23 interposed therebetween are formed.

Here, as shown in FIG. 4, outer corner portions of the second center leg 23 include round shapes, and all of corner portions of the second outer legs 24a and 24b include angled shapes (including round shapes having a much smaller radius than the round shapes of the outer corner portions of the second center leg). However, the disclosure is not limited thereto.

The recessed portions r1 and r2 are also formed on both sides of the second center leg 23, and thus the second outer legs 24a and 24b are spaced apart from the second center leg 23 by the predetermined intervals.

In the open area Ao, a recessed portion r3 is formed between the first lower center leg 21 and the second center leg 23 and between the first lower outer legs 22a and 22b and the second outer legs 24a and 24b, and thus the first lower center leg 21 and the second center leg 23 are spaced apart from each other by an interval equivalent to the recessed portion r3.

The upper core 10 is disposed over the closed area Ac of the lower core 20. A first upper center leg 11 is formed at the center of the upper core 10, and a pair of first upper outer legs 12a and 12b is disposed on the upper core 10, with the first upper center leg 11 interposed therebetween.

Recessed portions r4 and r5 are also formed on both sides of the first upper center leg 11, and thus the first upper outer legs 12a and 12b are spaced apart from the first upper center leg 11 by intervals equivalent to the recessed portions. In this embodiment, the recessed portions r4 and r5 in the upper core 10 and the recessed portions r1 and r2 in the lower core have the same width w as each other.

In addition, all of corner portions of the first upper center leg 11 include round shapes, and all of corner portions of the first upper outer legs 12a and 12b include angled shapes (including round shapes having a much smaller radius than the round shapes of the first center leg). However, the disclosure is not limited thereto.

The upper core 10 and the closed area Ac of the lower core 20 have shapes symmetrical to each other in an assembled state.

FIG. 5 illustrates the shape obtained by turning the upper core 10 shown in FIG. 3 over (FIG. 5(a)) and the shape of the right surface of the upper core 10 (FIG. 5(b)). In the assembled state shown in FIG. 3, the first upper center leg 11 of the upper core 10 is disposed on the first lower center leg 21, and the first upper outer leg 12b located on an upper part in FIG. 5 and the first upper outer leg 12a located on a lower part in FIG. 5 are disposed on the first lower outer leg 22b located on a lower part in FIG. 4 and the first lower outer leg 22a located on an upper part in FIG. 4, respectively.

Preferably, the upper core 10 is disposed above the lower core 20 by a predetermined distance. To this end, a gap may be formed between the first upper and lower center legs 11 and 21 and/or between the first upper and lower outer legs 12a, 12b, 22a, and 22b.

When the upper core 10 is disposed above the lower core 20, the first upper center leg 11 and the first lower center leg 21 form a first center leg, and the first upper outer legs 12a and 12b and the first lower outer legs 22a and 22b form first outer legs.

As shown in FIGS. 3 to 5, in the state in which the upper core 10 is disposed above the lower core 20, end surfaces of the first upper center leg 11, the pair of first upper outer legs 12a and 12b, the first lower center leg 21, and the pair of first lower outer legs 22a and 22b, which face the second center leg 23 and the pair of second outer legs 24a and 24b, may be located on the same imaginary plane P.

In this core structure, a primary coil 50 and a secondary coil 60 are disposed inside the core. The primary coil 50 is disposed in the closed area Ac and the open area Ao of the core in a state of being wound so as to surround the first center legs 11 and 21 and the second center leg 23, and the secondary coil 60 is disposed in the closed area Ac in a state of being wound so as to surround only the first center legs 11 and 21. In this case, a portion of the secondary coil 60 may also be disposed in the open area Ao beyond the closed area Ac. In this embodiment, the overall thickness of the primary coil 50 may be larger than the overall thickness of the secondary coil 60. However, the thickness of a strand of the secondary coil 60 is larger than that of a strand of the primary coil 50.

In addition, in this embodiment, the number of turns of the primary coil 50 is greater than the number of turns of the secondary coil 60.

The primary coil 50 and the secondary coil 60 are linked in the closed area Ac, but are not linked in the open area Ao. Voltage conversion is achieved in the closed area Ac in which the two coils 50 and 60 are linked, and leakage inductance generated in the closed area Ac is cancelled through leakage flux in the open area Ao in which the two coils 50 and 60 are not linked, thereby inducing leakage inductance having a desired magnitude. Like the conventional EE core, relatively large leakage inductance generated in the closed area Ac is cancelled through the open area Ac, whereby the total leakage inductance is adjusted to a lower level. Accordingly, it is possible to secure leakage inductance having a lower magnitude than before.

In the transformer of this embodiment, the leakage inductance may be adjusted depending on the size of the gap between the first lower center leg 21 and the second center leg 23 and/or between the first lower outer legs 22a and 22b and the second outer legs 24a and 24b, as will be described later.

Meanwhile, in this embodiment, the bobbin includes a first bobbin part 40 and a second bobbin part 30. As shown in FIG. 11, the first bobbin part 40 is assembled to the second bobbin part 30 in a manner of being inserted into a lower side of the second bobbin part 30.

In this embodiment, the first bobbin part 40 is provided with a primary coil receiving portion and a secondary coil receiving portion, and the second bobbin part 30 is provided with terminal portions for the primary coil 50 and the secondary coil 60.

The first bobbin part 40 includes an upper plate 41, an intermediate plate 42, and a lower plate 43. The secondary coil receiving portion is formed between the upper plate 41 and the intermediate plate 42, and the primary coil receiving portion is formed between the intermediate plate 42 and the lower plate 43.

The first bobbin part 40 has a first center leg through-hole 44 formed therethrough from the upper plate 41 to the lower plate 43, and the lower plate 43 has a second center leg receiving recess 47 formed therein so as to expand from the first center leg through-hole 44 to a primary terminal portion 32, which will be described later, to receive the second center leg 23 therein.

An upper rim 45 is formed between the upper plate 41 and the intermediate plate 42 so as to surround the upper portion of the first center leg through-hole 44, and a lower rim 46 is formed between the intermediate plate 42 and the lower plate 43 so as to surround the lower portion of the first center leg through-hole 44 and the second center leg receiving recess 47.

The primary coil receiving portion includes a space defined around the lower rim 46, and the secondary coil receiving portion includes a space defined around the upper rim 45. The primary coil 50 and the secondary coil 60 are respectively disposed in these spaces.

The first bobbin part 40 includes a pair of coil guides 41a and 41b formed on the upper plate 41 so as to protrude upward. In the state in which the first bobbin part 40 is coupled to the second bobbin part 30 in an insertion manner, the pair of core guides 41a and 41b protrudes higher above the upper surface of the second bobbin part 30, and the upper core 10 is located between the pair of core guides 41a and 41b. Due to the pair of core guides 41a and 41b, it is possible to easily determine the position of the core with respect to the bobbin (or coil).

The second bobbin part 30 has a primary terminal portion 32 and a secondary terminal portion 33 formed on both sides thereof, and has a body portion 31 formed between the terminal portions 32 and 33.

The primary terminal portion 32 includes first coil wire grooves 32a formed in first pin portions 32c formed on both sides thereof to allow terminal pins connected to terminals for the primary coil 50 to be insertedly fixed thereto, and includes first wiring protrusions 32b for wiring of coil wires (hereinafter referred to as terminal wires) leading to the terminals for the primary coil 50.

The secondary terminal portion 33 includes a plurality of second coil wire grooves 33a formed therein so as to be disposed in parallel, and second wiring protrusions 33b for wiring of coil wires are formed on the upper surface of the secondary terminal portion 33.

In this embodiment, the secondary coil 60 includes four individual coil wires, and each of the individual coil wires forms one turn for the secondary coil 60. Accordingly, the secondary terminal portion 33 of this embodiment includes a total of eight second coil wire grooves 33a. In this case, the secondary coil 60 may be led out through the second coil wire grooves 33a, and may be in contact with a separate terminal pin (not shown).

In addition, an intermediate plate receiving recess 36, which is a non-penetrating recess in which the intermediate plate 42 (or the lower plate 43) of the first bobbin part 40 is received, is formed in the lower portion of the second bobbin part 30. In addition, an upper plate receiving recess 34, which is a penetrating recess in which the upper plate 41 of the first bobbin part 40 is received, is formed in the second bobbin part 30.

Here, a plurality of fixing protrusions 36a is formed on the peripheral wall of the intermediate plate receiving recess 36 in order to prevent the intermediate plate 42 (or the lower plate 43) of the first bobbin part 40 received in the intermediate plate receiving recess 36 from being separated downward.

In addition, a first terminal wire passage 42a, through which the terminal wire of the primary coil 50 received in the primary coil receiving portion passes, is formed in the intermediate plate 42 of the first bobbin part 40, and a second terminal wire passage 35, through which the terminal wire of the primary coil 50 leads to the primary terminal portion 32, is formed in the second bobbin part 30 so as to correspond to the first terminal wire passage 42a. Protrusions 42b and 42c for fixing the coil wire of the primary coil 50 are formed on both sides of the first terminal wire passage 42a in the intermediate plate 42 of the first bobbin part 40.

In this embodiment, a peripheral wall 34a of the upper plate receiving recess 34 is formed so as to surround the secondary coil receiving space. The secondary coil 60 is received in the secondary coil receiving space defined in the space between the upper rim 45 of the first bobbin part 40 and the peripheral wall 34a of the upper plate receiving recess 34.

Here, as shown in FIG. 9, a portion of the peripheral wall 34a of the upper plate receiving recess 34 that abuts the secondary terminal portion 33 has a low height or is eliminated to form a passage through which the coil wire of the secondary coil 60 leads to the secondary terminal portion 33, and an inclined surface 37 that is gradually increased in width and height in a direction toward the secondary terminal portion 33 is formed in order to guide and support the terminal wires of the secondary coil 60, thereby increasing the freedom of arrangement of the terminal wires and facilitating a wiring process.

In this embodiment, the width of the first bobbin part 40 is equal to or smaller than the width of the body portion 31 of the second bobbin part 30. Therefore, in the state in which the first bobbin part 40 is coupled to the second bobbin part 30, the first bobbin part 40 does not protrude out of the body portion 31 of the second bobbin part 30.

In addition, the width of the body portion 31 of the second bobbin part 30 is equal to or smaller than the distance between the inner wall surfaces of the first outer legs 12a, 12b, 22a, and 22b. In the state in which the first bobbin part 40 and the second bobbin part 30 are coupled to each other, the height of a portion of the bobbin that is located inside the core is equal to or smaller than the height of the recessed portion (“height of r1+height of r4” or “height of r2+height of r5”) formed between the first center legs 11 and 21 and the first outer legs 12a, 12b, 22a, and 22b. Therefore, the bobbin is disposed inside the core so as to be aligned therewith. That is, in the state in which the primary coil 50 and the secondary coil 60 are disposed inside the first bobbin part 40 and the second bobbin part 30, the assembly thereof is completely received inside the cores 10 and 20.

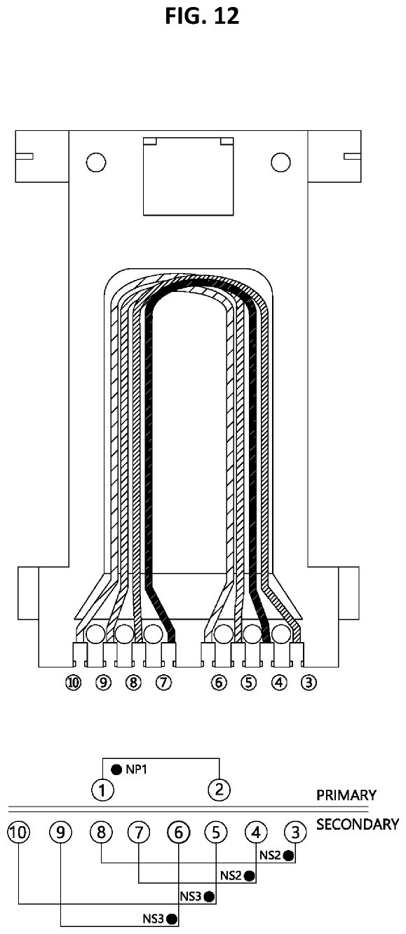

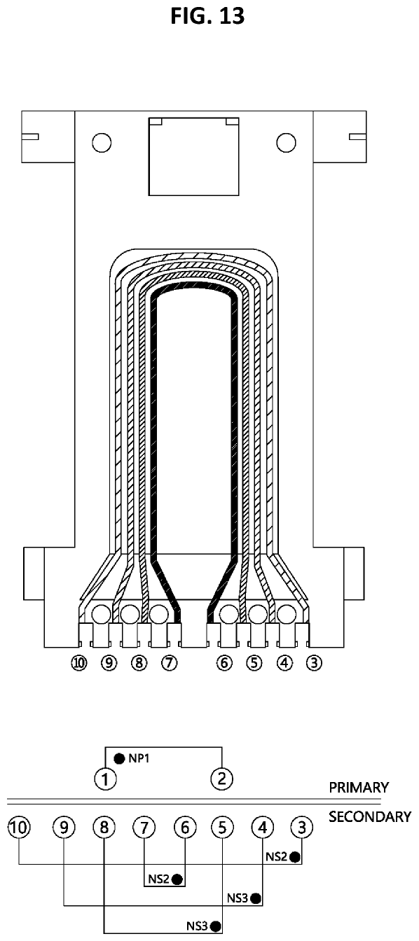

Meanwhile, FIG. 12 illustrates an embodiment of a method of winding the secondary coil 60 in the present disclosure, and FIG. 13 illustrates a comparative example of a method of winding the secondary coil 60 in the present disclosure.

The drawing shown in the upper part in FIG. 12 illustrates wiring of the secondary coil 60 according to a first embodiment on the second bobbin part 30, and the drawing shown in the lower part in FIG. 12 is a wiring diagram illustrating connection of the coil wires constituting the secondary coil 60 to the second terminal pins.

In this embodiment, the secondary coil 60 is wired such that the second terminal pins 10 and 9 are connected to the second terminal pins 5 and 6, respectively, and the second terminal pins 8 and 7 are connected to the second terminal pins 3 and 4, respectively.

Here, the second terminal pins 3 and 4 are (+) terminals, the second terminal pins 9 and 10 are (−) terminals, and the second terminal pins 5, 6, 7, and 8 are grounds.

Meanwhile, in the comparative example shown in FIG. 13, the secondary coil 60 is wound such that the second terminal pins 10 and 9 are connected to the second terminal pins 3 and 4, respectively, and the second terminal pins 8 and 7 are connected to the second terminal pins 5 and 6, respectively. Here, the second terminal pins 3 and 6 are (+) terminals, the second terminal pins 8 and 9 are (−) terminals, and the second terminal pins 4, 5, 7, and 10 are grounds.

Since the above-described method of winding the secondary coil 60 according to the embodiment makes the total lengths of the secondary output windings equal, it has effects of improving current unbalance between the coil wires of the secondary coil 60 compared to the comparative example. In addition, such a wiring and structure of the secondary coil 60 may increase the efficiency of the transformer by lowering resistance to current applied thereto, and may suppress generation of heat from the transformer by reducing the amount of heat generated due to resistance.

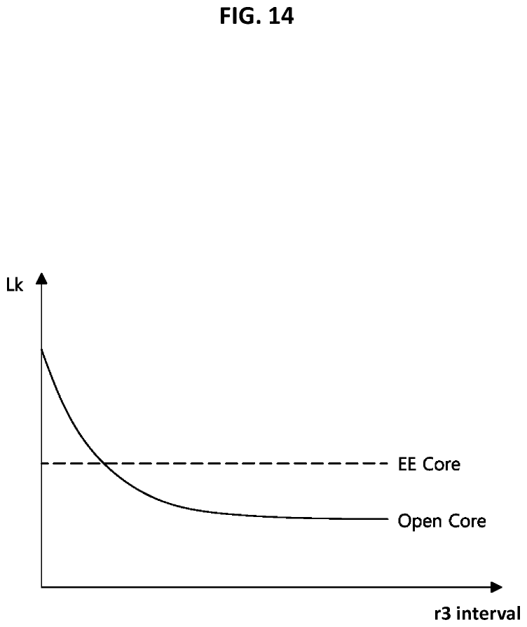

Meanwhile, FIG. 14 illustrates the relationship between leakage inductance in the core according to the embodiment of the present disclosure (indicated as “open core” in FIG. 14(b)) and the interval between the first lower center leg 21 and the second center leg 23 (r3 interval). As shown in FIG. 14, the leakage inductance in the core according to the embodiment of the present disclosure gradually decreases at a large rate of change as the interval increases, and thus may reach a level lower than that in the conventional EE core.

Therefore, the leakage inductance may be adjusted more precisely by adjusting the interval between the first center leg and the second center leg. In the case of high-frequency driving of 160 to 300 kHz, it is possible to adjust the leakage inductance to 15 to 20 μH.

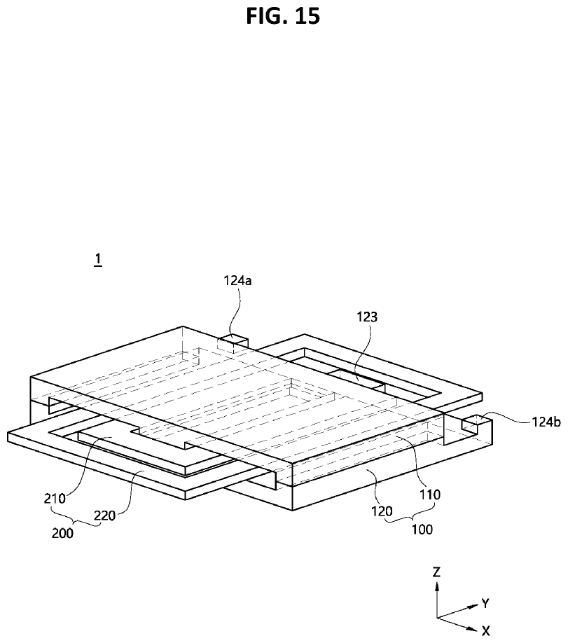

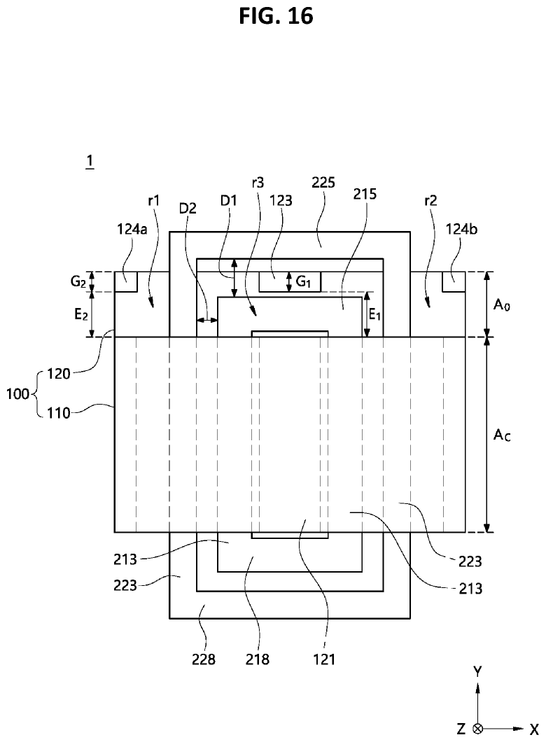

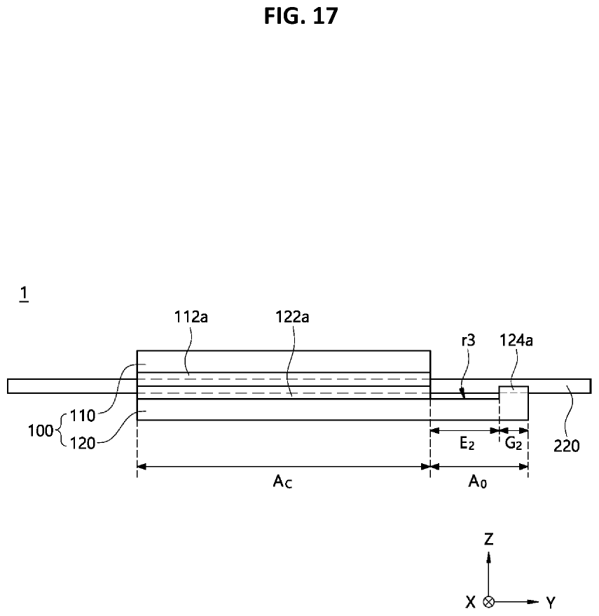

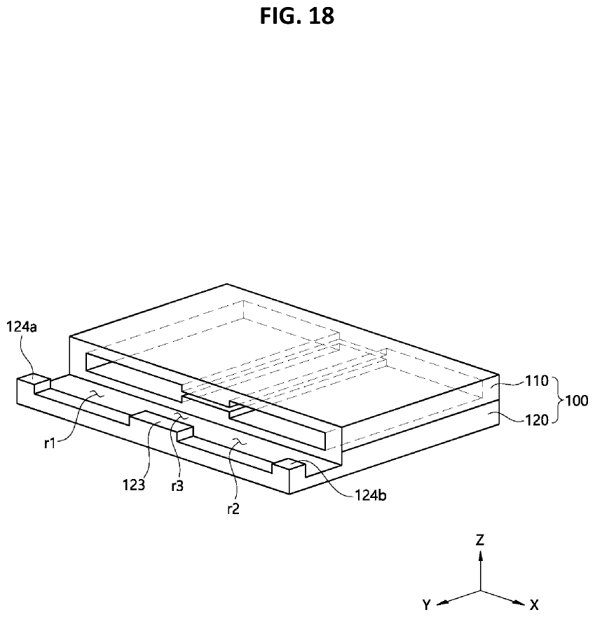

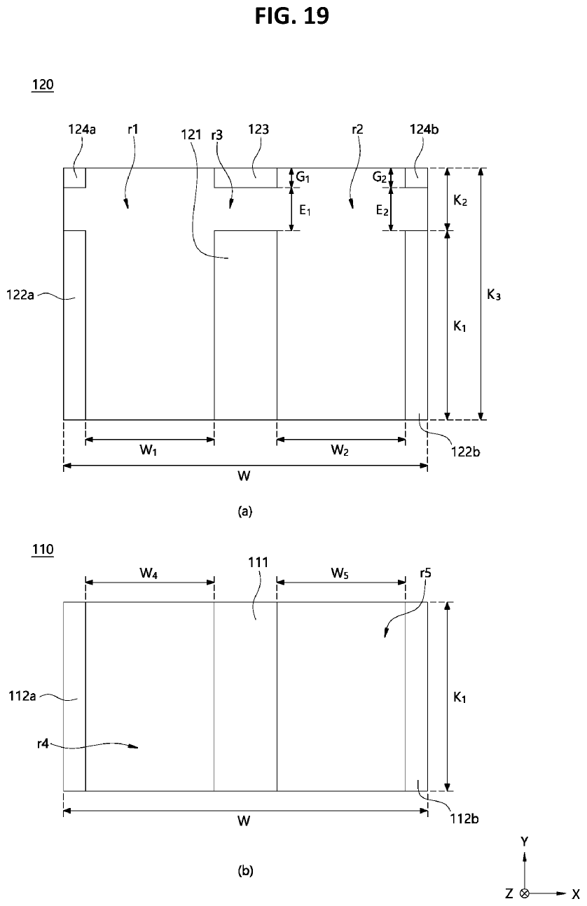

FIG. 15 is a perspective view of a transformer as one of magnetic components according to another embodiment of the present disclosure, FIG. 16 is a plan view of the transformer according to the other embodiment of the present disclosure, FIG. 17 is a side view of the transformer according to the other embodiment of the present disclosure, FIG. 18 is a perspective view of a core unit according to the other embodiment of the present disclosure, with a coil unit removed therefrom, and FIG. 19 is a plan view of an upper core and a lower core of the transformer according to the embodiment.

Referring to FIGS. 15 to 19, a transformer 1 according to another embodiment of the present disclosure includes a core unit 100 and a coil unit 200.

The core unit 100 includes an upper core 110 and a lower core 120, and the upper core 110 is disposed on the lower core 120 so as to overlap the lower core 120 in a first direction (z-axis direction) oriented from the lower side to the upper side of the lower core 120.

In detail, referring to FIGS. 18 and 19(b), the upper core 110 includes an upper center leg 111, which protrudes from one surface of a first base and is disposed in a center region of the first base, and first and second upper outer legs 112a and 112b, which are disposed on both sides of the upper center leg 111 so as to be spaced apart therefrom by a predetermined interval.

The first base may be formed to have a predetermined width in a third direction (X-axis direction). The width of the first base will be referred to as an overall width W. Since a second base of the lower core 120, which will be described below, is disposed so as to overlap the upper core 110, the overall width of the second base may also correspond to the overall width W. Since the upper center leg 111 and the first and second upper outer legs 112a and 112b are disposed on the first base so as to protrude, fourth and fifth recessed portions r4 and r5, which are relatively recessed by the upper center leg 111 and the first and second upper outer legs 112a and 112b, may be disposed in the upper core 110.

The fourth recessed portion r4 may be disposed between the upper center leg 111 and the first upper outer leg 112a, and the fifth recessed portion r5 may be disposed between the upper center leg 111 and the second upper outer leg 112b. The fourth and fifth recessed portions r4 and r5 may be disposed with a fourth width W4 and a fifth width W5, respectively. The fourth width W4 and the fifth width W5 may be equal to each other. However, the disclosure is not limited thereto. The fourth width W4 and the fifth width W5 may be different from each other.

Meanwhile, the first base of the upper core 110 may be formed to have a first length K1 in a second direction (Y-axis direction). Here, the lengths of the upper center leg 111, the first upper outer leg 112a, and the second upper outer leg 112b may be set to be equal to the first length K1. However, the disclosure is not limited thereto.

Referring to FIGS. 18 and 19(a), the lower core 120 includes a first lower center leg 121 and a second lower center leg 123, which protrude from one surface of the second base and are disposed in the center region of the second base. The first lower center leg 121 and the second lower center leg 123 may be spaced apart from each other by a predetermined interval in the second direction (Y-axis direction). Here, the distance by which the first lower center leg 121 and the second lower center leg 123 are spaced apart from each other may be a first separation distance E1. A third recessed portion r3, which will be described later, may be formed between the first lower center leg 121 and the second lower center leg 123.

In addition, the lower core 120 includes first and second lower outer legs 122a and 122b disposed on both sides of the first lower center leg 121 so as to be spaced apart therefrom by a predetermined interval and third and fourth lower outer legs 124a and 124b disposed on both sides of the second lower center leg 123 so as to be spaced apart therefrom by a predetermined interval. The spacing distance between the first lower center leg 121 and the first lower outer leg 122a may be set to a first width W1, and the spacing distance between the first lower center leg 121 and the second lower outer leg 122b may be set to a second width W2. The spacing distance between the second lower center leg 123 and the third lower outer leg 124a may also be set to the first width W1 in consideration of formability of the lower core 120. In addition, the spacing distance between the second lower center leg 123 and the fourth lower outer leg 124b may also be set to the second width W2.

Identical to the first base, the second base may be formed to have the overall width W in the third direction (X-axis direction). First and second recessed portions r1 and r2, which are relatively recessed by the first lower center leg 121, first and second lower outer legs 122a and 122b, the second lower center leg 123, and the third and fourth lower outer legs 124a and 124b, may be disposed in the lower core 120.

The first recessed portion r1 may be disposed between the first lower center leg 121 and the first lower outer leg 122a and between the second lower center leg 123 and the third lower outer leg 124a. The second recessed portion r2 may be disposed between the first lower center leg 121 and the second upper outer leg 112b and between the second lower center leg 123 and the fourth lower outer leg 124b.

The first and second recessed portions r1 and r2 may be disposed with a first width W1 and a second width W2, respectively. The first width W1 and the second width W2 may be equal to each other. However, the disclosure is not limited thereto. The first width W1 and the second width W2 may be different from each other.

In addition, the widths of the first and second recessed portions r1 and r2 may be set to respectively correspond to the widths of the fourth and fifth recessed portions r4 and r5. However, the disclosure is not limited thereto. This embodiment will be described on the assumption that the widths of the first and second recessed portions r1 and r2 respectively correspond to the widths of the fourth and fifth recessed portions r4 and r5.

Meanwhile, the second base of the lower core 120 may be formed to have a third length K3 in the second direction (Y-axis direction). Here, the third length K3 may be a length obtained by summing the first length K1 and the second length K2. When the lower core 120 is coupled to the upper core 110, the region of the first length K1 may be a region in which the lower core 120 and the upper core 110 overlap each other, and the region of the second length K2 may be a region in which the lower core 120 is exposed from the upper core 110.

A first thickness G1 of the second lower center leg 123 formed in the second direction (Y-axis direction) and a first separation distance E1 formed in the second direction (Y-axis direction) may be disposed in the region of the second length K2. In addition, a second thickness G2 of the third and fourth lower outer legs 124a and 124b and a second separation distance E2 between the first and second lower outer legs 122a and 122b and the third and fourth lower outer legs 124a and 124b may be disposed in the region of the second length K2.

Here, in consideration of formability of the lower core 120, this embodiment will be described on the assumption that the first thickness G1 and the second thickness G2 are equal to each other and the first separation distance E1 and the second separation distance E2 are equal to each other. Although the first thickness G1 and the second thickness G2 will be described as being equal to each other, the disclosure is not limited thereto. The first thickness G1 and the second thickness G2 may be different from each other. In addition, although the first separation distance E1 and the second separation distance E2 will be described as being equal to each other, the disclosure is not limited thereto. The first separation distance E1 and the second separation distance E2 may be different from each other.

The first lower center leg 121, the first lower outer leg 122a, and the second lower outer leg 122b may be formed to have a length equal to the first length K1 so as to correspond to the upper center leg 111, the first upper outer leg 112a, and the second upper outer leg 112b, respectively. However, the disclosure is not limited thereto.

The second lower center leg 123, the third lower outer leg 124a, and the fourth lower outer leg 124b may be disposed in the region of the second length K2. In addition, the first separation distance E1 between the second lower center leg 123 and the first lower center leg 121, the second separation distance E2 between the third lower outer leg 124a and the first lower outer leg 122a, and the second separation distance E2 between the second upper outer leg 112b and the fourth lower outer leg 124b may be formed in the region of the second length K2. The second base and the third recessed portion r3, which is relatively recessed by the center leg and the outer legs protruding from the second base, may be disposed in a region defined by the first separation distance E1 and the second separation distance E2.

As such, since the upper core 110 and the lower core 120 are formed to have different lengths, the core unit 100 includes a closed area Ac in which the upper core 110 and the lower core 120 overlap each other and an open area Ao in which the lower core 120 is exposed by the upper core 110.

Here, in this embodiment, the planar area of the open area Ao may be smaller than the planar area of the closed area Ac. In other words, the region of the second length K2 may be disposed so as to be smaller than the region of the first length K1.

For example, the closed area Ac may be an area that is covered and closed by overlapping the upper core 10 in the first direction (z-axis direction) oriented from the lower core 120 to the upper core 110, and the open area Ao may be an area that extends from the closed area Ac in the second direction perpendicular to the first direction (z-axis direction) and is exposed to the outside of the closed area Ac without being covered by the upper core 10.

The closed area Ac may be disposed in the region of the first length K1, the first lower center leg 121 and the upper center leg 111 may be disposed therein so as to overlap each other, the first upper outer leg 112a and the first lower outer leg 122a may be disposed therein so as to overlap each other, and the second upper outer leg 112b and the second lower outer leg 122b may be disposed therein so as to overlap each other. In addition, the first and second recessed portions r1 and r2 and the fourth and fifth recessed portions r4 and r5, which are relatively recessed, may be disposed therein so as to overlap each other.

The open area Ao may be disposed in the region of the second length K2, the second lower center leg 123, the third lower outer leg 124a, and the fourth lower outer leg 124b may be disposed therein, and the third recessed portion r3, which is disposed between the second lower center leg 123, the third lower outer leg 124a, the fourth lower outer leg 124b, and the closed area Ac, may be disposed therein.

In addition, a region in which the first and second recessed portions r1 and r2 and the fourth and fifth recessed portions r4 and r5 do not overlap each other may be disposed in the open area Ao. Hereinafter, a region in which the first and second recessed portions r1 and r2 and the fourth and fifth recessed portions r4 and r5 overlap each other will be referred to as the fourth and fifth recessed portions r4 and r5, and a region in which the first and second recessed portions r1 and r2 and the fourth and fifth recessed portions r4 and r5 do not overlap each other will be referred to as the first and second recessed portions r1 and r2.

Referring again to FIGS. 15 to 19, the coil unit 200 includes a first coil 210 and a second coil 220 penetrating the core unit 100. Here, for convenience of explanation, the first coil 210 and the second coil 220 will be described as being formed in a rectangular loop shape.

The first coil 210 may be disposed so as to surround the region in which the upper center leg 111 and the first lower center leg 121 overlap each other. In detail, the first coil 210 includes a first vertical coil portion 213, which extends in the Y-axis direction and is disposed in the fourth and fifth recessed portions r4 and r5, a 1-1^{st} horizontal coil portion 215, which extends in the X-axis direction and is disposed between the second lower center leg 123 and the first lower center leg 121, and a 1-2^{nd} horizontal coil portion 218, which is disposed opposite the 1-1^{st} horizontal coil portion 215.

The 1-1^{st} horizontal coil portion 215 of the first coil 210 may be disposed in the third recessed portion r3 formed in the open area Ao. Therefore, the 1-1^{st} horizontal coil portion 215 of the first coil 210 may be disposed in the region of the second length K2 that does not overlap the upper core 110. Therefore, the third recessed portion r3 may be formed with a width capable of receiving the 1-1^{st} horizontal coil portion 215 of the first coil 210. For example, the third recessed portion r3 disposed in the region defined by the first separation distance E1 may be formed to have a thickness of 3 mm to 20 mm in the Y-axis direction.

In this case, the thickness of the third recessed portion r3 is determined by the diameter of the secondary coil wire in the Y-axis direction. The thickness needs to be greater than or equal to 3 mm so that a secondary coil suitable for allowable current is used. However, if the thickness exceeds 20 mm, core loss increases, and thus performance is not sufficiently improved.

The first vertical coil portion 213 of the first coil 210 may be disposed in the fourth and fifth recessed portions r4 and r5 in which the upper core 110 and the lower core 120 overlap each other, and a portion thereof may be disposed in the region in which the first and second recessed portions r1 and r2 and the third recessed portion r3 overlap each other in order to be connected to the 1-1^{st} horizontal coil portion 215. In other words, a portion of the first vertical coil portion 213 may be disposed in the closed area Ac, and the remaining portion thereof may be disposed in the open area Ao.

The 1-2^{nd} horizontal coil portion 218 of the first coil 210 may be disposed outside the closed area Ac, that is, outside the region of the first length K1. That is, the first vertical coil portion 213 may be disposed outside the region of the first length K1, the region of the second length K2, and the region of the first length K1. Here, the region outside the region of the first length K1 is a region that is located outside the region of the first length K1 opposite the region of the second length K2.

The second coil 220 may be disposed so as to surround the region in which the upper center leg 111 and the first lower center leg 121 overlap each other and the second lower center leg 123. In detail, the second coil 220 includes a second vertical coil portion 223, which extends in the Y-axis direction and is disposed in the fourth and fifth recessed portions r4 and r5, a 2-1^{st} horizontal coil portion 225, which extends in the X-axis direction, is adjacent to the second lower center leg 123, and is disposed outside the closed area Ac, and a 2-2^{nd} horizontal coil portion 228, which is disposed opposite the 2-1^{st} horizontal coil portion 225.

The 2-1^{st} horizontal coil portion 225 of the second coil 220 may be disposed outside the closed area Ac. In other words, the 2-1^{st} horizontal coil portion 225 may be disposed outside the region of the second length K2 that is adjacent to the second lower center leg 123. Therefore, the 2-1^{st} horizontal coil portion 225 may be disposed so as to be spaced apart from the 1-1^{st} horizontal coil portion 215 by a first spacing distance D1.

The first spacing distance D1 may be equal to or greater than the thickness of the second lower center leg 123 in the Y-axis direction that is disposed between the 2-1^{st} horizontal coil portion 225 and the 1-1^{st} horizontal coil portion 215. For example, the first spacing distance D1 may be equal to or greater than 2 mm and less than 15 mm. When the first spacing distance D1 is less than 2 mm, the first thickness G1 of the second lower center leg 123 in the Y-axis direction decreases, which causes magnetic field loss, thereby deteriorating performance of the second lower center leg 123. When the first spacing distance D1 is equal to or greater than 15 mm, the spacing distance to the first coil increases, which causes loss in the second coil. Therefore, it is preferable for the first spacing distance D1 to be equal to or greater than 2 mm and less than 15 mm.

The second vertical coil portion 223 of the second coil 220 may be disposed in the fourth and fifth recessed portions r4 and r5 in which the upper core 110 and the lower core 120 overlap each other, and a portion thereof may be disposed in the first and second recessed portions r1 and r2 and the region in which the first and second recessed portions r1 and r2 and the third recessed portion r3 overlap each other in order to be connected to the 2-1^{st} horizontal coil portion 225. In addition, the remaining portion thereof may be disposed outside the closed area Ac in order to be connected to the 2-1^{st} horizontal coil portion 225.

In other words, a portion of the second vertical coil portion 223 may be disposed in the closed area Ac, another portion thereof may be disposed in the open area Ao, and the remaining portion thereof may be disposed outside the open area Ao. Therefore, the second vertical coil portion 223 of the second coil 220 may be formed to be longer than the region of the first length K1 and the region of the second length K2.

Here, the first vertical coil portion 213 and the second vertical coil portion 223 may be disposed in the fourth and fifth recessed portions r4 and r5 or the first and second recessed portions r1 and r2 so as to be spaced apart from each other by the aforementioned first spacing distance D1. Alternatively, the first vertical coil portion 213 and the second vertical coil portion 223 may be spaced apart from each other by a second spacing distance D2 that is different from the first spacing distance D1. The reason why the first vertical coil portion 213 and the second vertical coil portion 223 are spaced apart from each other by different spacing distances is that there is a limitation on the extent to which the overall width W of the core unit 100 is increased in order to implement a lightweight and small transformer. Therefore, the aforementioned second spacing distance D2 may be less than the first spacing distance D1.

The 2-2^{nd} horizontal coil portion 228 of the second coil 220 may be disposed outside the closed area Ac, that is, outside the region of the third length K3.

Meanwhile, the first coil 210 and the second coil 220 may be formed to have different thicknesses. For example, the thickness of the first coil 210 may be greater than the thickness of the second coil 220. In addition, in order to make the thickness of the first coil 210 greater than that of the second coil 220, the number of turns of the first coil 210 may be set to be greater than the number of turns of the second coil 220.

The first coil 210 and the second coil 220 may be linked in the closed area Ac, but may not be linked in the open area Ao. Voltage conversion is achieved in the closed area Ac in which the first coil 210 and the second coil 220 are linked, and leakage inductance generated in the closed area Ac is cancelled through leakage flux in the open area Ao in which the two coils are not linked, thereby inducing leakage inductance having a desired magnitude.

In this way, the first spacing distance D1, which is the spacing distance between the first coil 210 and the second coil 220, is adjusted without adjusting the sizes of the upper center leg 111 and the first lower center leg 121, thereby inducing leakage inductance having a desired magnitude while maintaining a constant self-inductance value Lp.

Accordingly, the transformer 1 of this embodiment may adjust leakage inductance by adjusting the interval between the first lower center leg 121 and the second lower center leg 123 and/or the interval between the first lower outer leg 122a and the third lower outer leg 124a and/or the interval between the second upper outer leg 122b and the fourth lower outer leg 124b.

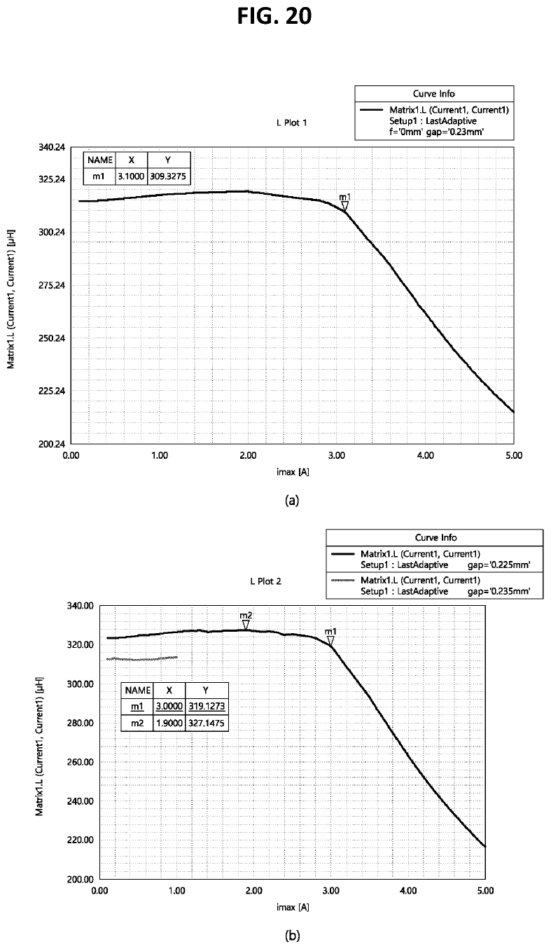

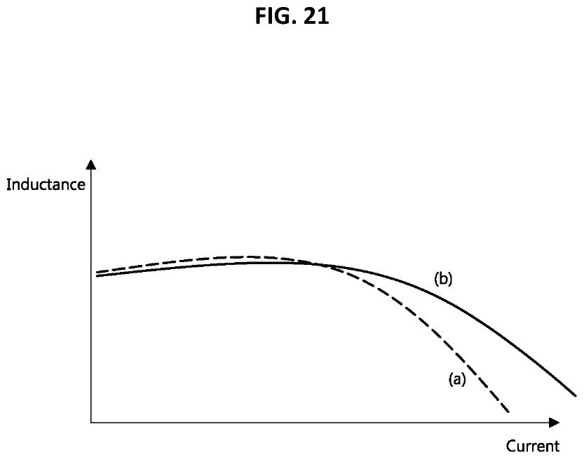

FIG. 20(a) is a graph showing leakage inductance measured in the conventional transformer having no open area, FIG. 20(b) is a graph showing leakage inductance measured in the transformer according to the other embodiment of the present disclosure in which the open area is disposed, and FIG. 21 is a graph showing comparison in current density with respect to inductance between the transformer according to the embodiment and the conventional transformer.

Referring to FIGS. 20(a) and 21, it can be seen that large leakage inductance is generated due to the closed area Ac in the transformer in which only the closed area Ac is disposed, like the conventional EE core. It can be seen that leakage inductance of 3.1 A is generated in a region m1 in the graph.

On the other hand, referring to FIGS. 20(b) and 21, it can be seen that leakage inductance having a magnitude lower than before is secured by cancelling leakage inductance through the open area Ao and lowering the leakage inductance. It can be seen that leakage inductance of 3 A is generated in a region m1 in the graph.

When the same current is applied to the conventional transformer and the transformer of this embodiment, magnetic flux flows are cancelled between the first lower center leg 121 and the second lower center leg 123 in the transformer of this embodiment. Thus, even when a high current flows, the values of magnetic flux and current density induced again in the coil unit 200 may be low. This is because saturation of the core unit 100 is prevented by additionally accommodating the flux density through the open area Ao.

Therefore, it can be seen that the open area Ac serves to additionally store energy, whereby high power accommodation performance is improved. That is, it can be seen that the transformer according to this embodiment exhibits improved DC-bias performance compared to the conventional core.

Accordingly, in the transformer 1 according to the embodiment, the first spacing distance D1, which is the spacing distance between the first coil 210 and the second coil 220, is adjusted without adjusting the sizes of the upper center leg 111 and the first lower center leg 121, thereby inducing leakage inductance having a desired magnitude while maintaining a constant self-inductance value Lp. That is, DC-bias of the transformer may be increased at the same self-inductance Lp.

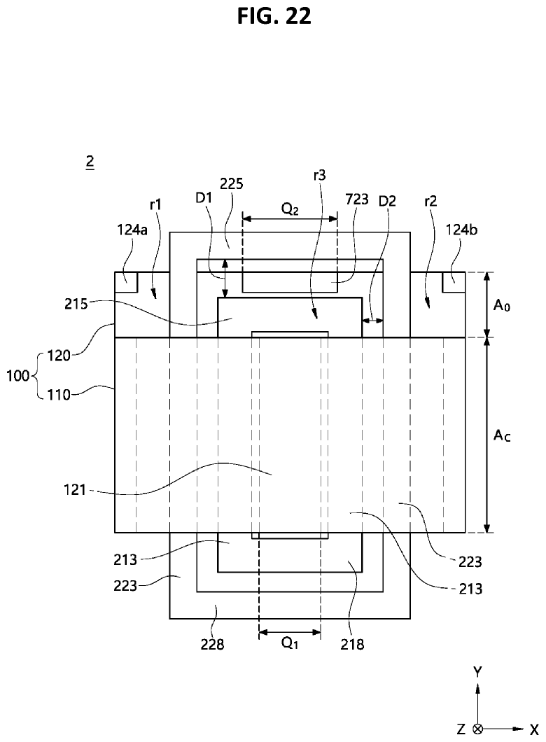

FIG. 22 is a plan view showing a transformer according to still another embodiment of the present disclosure.

A detailed description of the embodiment shown in FIG. 22 will be omitted to avoid redundancy, and FIGS. 15 to 21 will be referenced for ease of description.

Referring to FIG. 22, a transformer 2 according to the still other embodiment of the present disclosure may include a first lower center leg 121 having a first width Q1 in the X-axis direction and a second lower center leg 123 having a second width Q2 in the X-axis direction.

The second width Q2 may be set to be greater than the first width Q1 by 10% to 150%.

Referring to FIG. 16 for easy comparison with the previous embodiment, the first lower center leg 121 and the second lower center leg 123 may be formed to have the same first width Q1. The first lower center leg 121 and the second lower center leg 123 having the same first width Q1 may be easily formed.

In the transformer 2 according to the still other embodiment, since the first lower center leg 121 and the second lower center leg 123 are formed to have different widths, the open area Ao serves to additionally store energy, whereby high power accommodation performance is improved. Accordingly, saturation of the core unit 100 is prevented by additionally accommodating the flux density through the open area Ac.

As a result, in the transformer 2 according to the still other embodiment, since the first lower center leg 121 and the second lower center leg 123 are formed to have different widths, it is possible to induce leakage inductance having a desired magnitude while maintaining a constant self-inductance value Lp. That is, DC-bias of the transformer may be increased at the same self-inductance Lp.

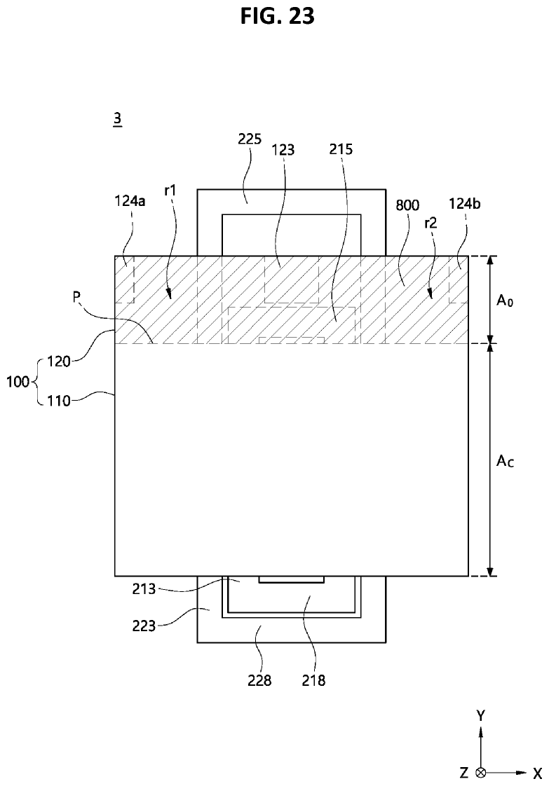

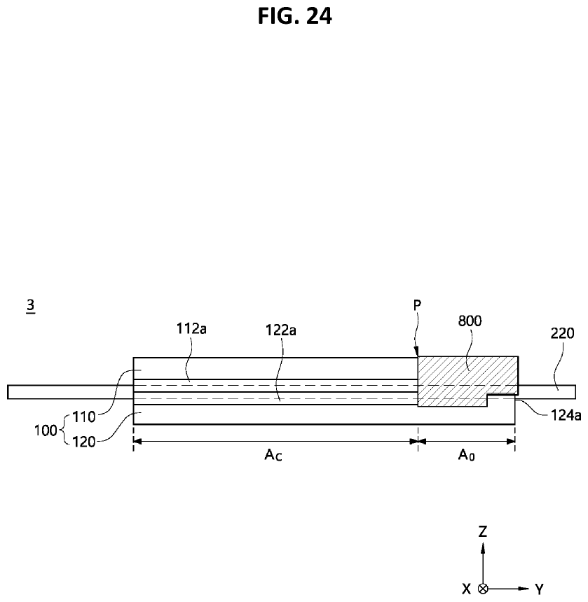

FIG. 23 is a plan view of a transformer according to a further embodiment, and FIG. 24 is a side view of the transformer according to the further embodiment.

A detailed description of the embodiment shown in FIGS. 23 and 24 will be omitted to avoid redundancy, and FIGS. 15 to 22 will be referenced for ease of description.

Referring to FIGS. 23 and 24, a transformer 3 according to the further embodiment may include a heat dissipation member 800 disposed over the open area Ao. The heat dissipation member 800 may cover a portion of the first coil 2100, a portion of the second coil 220, and a portion of the lower core 120.

The heat dissipation member 800 may be disposed over the region of the second length K2 in the open area Ao. The second lower center leg 123, the third lower outer leg 124a, the fourth lower outer leg 124b, and the third recessed portion r3 may be disposed in the region of the second length K2. In addition, the second vertical coil portion 223 and the first vertical coil portion 213, which are disposed in the region in which the first and second recessed portions r1 and r2 and the third recessed portion r3 overlap each other, may be disposed in the region of the second length K2.

Therefore, the heat dissipation member 800 may be disposed so as to cover the second vertical coil portion 223, the first vertical coil portion 213, the second lower center leg 123, the third lower outer leg 124a, the fourth lower outer leg 124b, and the third recessed portion r3.

Here, the heat dissipation member 800 may be disposed so as not only to cover the above components but also to directly contact the same, thereby dissipating thermal energy generated from the core unit 100 and the coil unit 200 to the outside. In other words, the heat dissipation member 800 may be disposed so as to directly contact the coil unit 200, the upper core 110, and the lower core 120.

In detail, the heat dissipation member 800 may be disposed so as to directly contact the upper surfaces and the side surfaces of the second vertical coil portion 223 and the first vertical coil portion 213. In addition, the heat dissipation member 800 may be disposed so as to directly contact one surface of the lower core 120 disposed in the open area Ao.

In detail, the heat dissipation member 800 may be disposed so as to directly contact one surface of the second base of the lower core 120, and may be disposed so as to directly contact the thickness surface and the upper surface of the second lower center leg 123 protruding from one surface of the second base, the thickness surface and the upper surface of the third lower outer leg 124a, and the thickness surface and the upper surface of the fourth lower outer leg 124b.

In addition, the heat dissipation member 800 may be disposed so as to directly contact the side surface of the upper core 110 disposed at the boundary P between the region of the first length K1 and the region of the second length K2.

In more detail, the heat dissipation member 800 may be disposed so as to directly contact the thickness surface of the first base, from which the upper core 110 is exposed at the boundary P, the thickness surface of the upper center leg 111, the thickness surface of the first upper outer leg 112a, and the thickness surface of the second upper outer leg 112b.

Further, since the thickness surface of the first lower center leg 121, the thickness surface of the first lower outer leg 122a, and the thickness surface of the second upper outer leg 122b, which overlap the upper center leg 111, the first upper outer leg 112a, and the second upper outer leg 112b, respectively, are exposed at the boundary P, these thickness surfaces may directly contact the heat dissipation member 800.

Therefore, the heat dissipation member 800, which is disposed so as to directly contact the aforementioned components, directly contacts a portion of the upper core 110 and a portion of the lower core 120 at the boundary P as well as in the open area Ao, thereby efficiently dissipating thermal energy generated in the closed area Ac to the outside.

The heat dissipation member 800 may be disposed over the open area Ao, and may have a thickness allowing the heat dissipation member 800 to be disposed parallel to the other surface of the first base of the first coil 210. Here, the other surface of the first base is a surface opposite one surface of the first base on which the first upper outer leg 112a, the second upper outer leg 112b, and the upper center leg 111 are formed.

In another embodiment, the heat dissipation member 800 may have a thickness allowing the upper surface of the third lower outer leg 124a, the upper surface of the fourth lower outer leg 124b, and the upper surface of the second lower center leg 123 to be exposed. In other words, when the thickness of the heat dissipation member 800 is reduced, material costs may be reduced, and heat conduction resistance of the heat dissipation member 800 may be minimized. Accordingly, heat dissipation effect may be improved.

In still another embodiment, a bobbin configured to allow the heat dissipation member 800 and the coil unit 200 to be disposed thereon may be disposed between the upper core 110 and the lower core 120.

The heat dissipation member 800 may be formed of an insulating material having insulating characteristics of 500 v/mm or more and thermal conductivity of 3.0 W/mK or more. For example, the heat dissipation member 800 may be formed of any one of an alumina (Al₂O₃)-based material, a boron nitride (BN)-based material, a silicon (Si)-based material, and mixtures thereof.

The heat dissipation member 800 may dissipate heat generated from the core unit 100 and the coil unit 200, thereby minimizing an increase in temperature of the transformer 3, thus achieving thermal equilibrium in the transformer 3.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

### INDUSTRIAL APPLICABILITY

A transformer and a circuit board including the same according to the present disclosure may be used for power supply units of electronic products.

1-14. (canceled)

15. A transformer comprising:
a core unit comprising a lower core and an upper core;
a bobbin unit at least partially disposed inside the core unit; and
a coil unit at least partially disposed inside the bobbin unit, the coil unit comprising a primary coil and a secondary coil disposed so as to be spaced apart from each other in a second direction intersecting a first direction oriented from the upper core to the lower core,
wherein the lower core comprises:
a closed area overlapping the upper core in the first direction;
an open area extending from the closed area in a third direction intersecting the first direction and the second direction so as to be spaced apart from the upper core;
a pair of first lower outer legs and a first lower center leg disposed in the closed area, the first lower center leg being disposed between the pair of first lower outer legs; and
a pair of second lower outer legs and a second lower center leg disposed in the open area, the second lower center leg being disposed between the pair of second lower outer legs,
wherein the first lower center leg and the second lower center leg are disposed so as to be spaced apart from each other,
wherein one of the primary coil and the secondary coil is at least partially disposed between the first lower center leg and the second lower center leg, and
wherein the primary coil, the secondary coil, and the first lower center leg at least partially overlap each other in the second direction.

16. The transformer according to claim 15, wherein the primary coil, the secondary coil, the first lower center leg, and the second lower center leg at least partially overlap each other in the third direction.

17. The transformer according to claim 16, wherein a remaining one of the primary coil and the secondary coil is disposed in the closed area and the open area so as to surround the first lower center leg and the second lower center leg.

18. The transformer according to claim 17, wherein the secondary coil is disposed closer to the first lower center leg than is the primary coil.

19. The transformer according to claim 18, wherein a length of the primary coil in the third direction is longer than a length of the secondary coil in the third direction.

20. The transformer according to claim 15, wherein an area of the closed area in the first direction is larger than an area of the open area in the first direction.

21. The transformer according to claim 20, wherein a distance between the first lower center leg and the second lower center leg is longer than a length of the second lower center leg in the third direction.

22. The transformer according to claim 21, wherein the distance between the first lower center leg and the second lower center leg is 3 to 20 mm.

23. The transformer according to claim 15, wherein the upper core comprises a first upper center leg disposed above the first lower center leg, and wherein an end surface of the first lower center leg facing the second lower center leg and an end surface of the first upper center leg facing the second lower center leg are disposed on a same imaginary plane.

24. The transformer according to claim 23, wherein the upper core comprises a pair of first upper outer legs disposed above the first lower outer legs, respectively, and an end surface of each of the pair of first lower outer legs facing the pair of second lower outer legs and an end surface of each of the pair of first upper outer legs facing the pair of second lower outer legs are disposed on a same imaginary plane.

25. The transformer according to claim 23, wherein a gap is formed between the first lower center leg and the first upper center leg.

26. The transformer according to claim 25, wherein the primary coil has a greater number of turns than does the secondary coil.

27. A circuit board comprising the transformer described in claim 15.

28. The circuit board according to claim 27, wherein the transformer has leakage inductance of 15 to 20 μH at a frequency of 160 to 300 KHz.
